(19) United States
(12) Patent Application Publication
(10) Pub. No.: US 2021/0283877 A1
(43) Pub. Date: Sep. 16, 2021

(54) DEVICE FOR PROVIDING INSERTS AS SUPPORTING MESHES ON A TABLET MACHINE, AND A METHOD FOR PRODUCING A PELLET WHICH INCLUDES A SUPPORTING MESH

(71) Applicant: KORSCH AG, Berlin (DE)

(72) Inventors: Wolfgang KORSCH, Berlin (DE); Michael SCHMETT, Potsdam (DE); Stephan MIES, Berlin (DE)

(73) Assignee: KORSCH AG, Berlin (DE)

(21) Appl. No.: 17/262,146

(22) PCT Filed: Jul. 12, 2019
(86) PCT No.: PCT/EP2019/068792

§ 371 Date: Jan. 21, 2021

(30) Foreign Application Priority Data
Jul. 25, 2018 (EP) 18185391.2

(51) Int. Cl. B30B 11/34; B30B 15/30; B28B 3/02; B28B 11/24; C01G 45/02

(52) U.S. Cl. CPC B30B 11/34; B30B 15/30; C01G 45/02; B28B 11/243; B28B 3/02

(57) ABSTRACT

The invention relates to a device for providing supporting meshes for use as inserts in a pellet on a tablet machine, and a method for producing a pellet which includes an insert or supporting mesh.

The invention relates to a device for producing objects for use as inserts in a pellet on a tablet machine, and a method for producing a tablet which includes an insert.

### BACKGROUND AND PRIOR ART

Tablet machines are used in many branches of industry to process powdered or granulated materials into solid pellets. In the pharmaceuticals industry, this may involve numerous forms of tablets, in the chemicals industry this may involve dishwashing detergent tablets, toilet cleaner tablets, fertilizer sticks, or catalysts, and in the foods industry it may involve peppermint tablets or glucose tablets, for example. Above all the sub-class of rotary presses was developed primarily for producing solid and stable pellets in large numbers from powdery or granulated compression materials within extremely narrow weight tolerances. This pressing compound is preferably also referred to in terms of the invention as tablet material. In general, the tablet material is fed via the material feed to a filling device. The filling device is arranged above the die plate, wherein the pellets are produced in the openings or bores of the die plate in that upper punch and lower punch are pressed into the openings or bores with great pressure onto the pressing material located between the pressing tools. The pressing tools are typically formed by upper and lower punches.

For example, rotary presses are used in the technical-chemical field to produce components of batteries, for example button cells. Button cells are usually constructed as follows in the prior art. The button cell generally consists of a cup, into which a tablet made of metal oxide powder is inserted and pressed in. The pellet made of metal oxide powder which is pressed into a cup is preferably referred to as a cathode, since it can assume the function of a cathode within the produced battery. The cathode can then in particular be further processed to form a button cell.

For example, silver oxide button cells are produced as cathodes, which have a compact shape having essentially circular footprint and a diameter between approximately 5 and 11 mm and a height of approximately 0.5 to 3 mm. The silver oxide tablets thus produced are very stable and can, for example, have dust removed mechanically using a vibrator and can be stored as bulk material in cans or other containers. Furthermore, the silver oxide tablets can be transported as bulk material without being damaged.

However, it has been shown that the conventional production methods known, for example, for silver oxide tablets are not suitable for producing other metal oxide tablets, since the different materials sometimes have completely different material properties or flow properties. Additional measures can possibly be necessary to obtain processable pellets at all. For example, materials are known which have a certain residual moisture for various reasons upon being fed to the tablet machine. In particular if such “moist” materials are to be processed into pellets having large diameters and low heights, problems can occur with respect to the stability and strength of the pellets. It has been shown that the pellets made of such materials are very sensitive, and that they cannot be further processed readily using conventional means. In particular, damages, such as broken-off edges or shattered tablets, occur frequently with such pellets.

To increase the stability and the strength of such “moist” metal oxide tablets, for example, it has been proposed that supporting meshes be incorporated into the pellets in the production process. This can take place manually, for example, which is obviously very cumbersome and is linked to a high expenditure for personnel and finance. In particular, the production expenditure for such tablets having supporting meshes is also very high, since multiple machines often have to be used in order to execute the various work steps required in succession. Keeping various machines ready, which can only be used to carry out very special tasks, is undesirable from an economic aspect, however. In particular, rotary presses, using which supporting meshes can be pressed into pellets, are not known in the prior art. This is in particular because the technical world has previously presumed that a continuously operating rotary press is not suitable for processing inserts, which are typically fed cyclically, with a desired production performance.

Although there are individual machines, using which supporting mesh pellets can be produced, these are frequently costly and complex special machines, using which tablet material having a high level of residual moisture can be compressed into pellets having improved stability and strength. Such special machines are frequently designed as robots. However, purchasing such a special machine is frequently linked to a high financial expenditure and once the machine is purchased, it has to be utilized well in order to financially justify its acquisition. Such special machines are disadvantageously only produced in small numbers, so that the maintenance and the repair are frequently very time-consuming and costly, because there are only a few trained technicians in the corresponding technical field. Furthermore, long shutdown times can occur when there are bottlenecks in the supply of replacement parts due to the small numbers of the machines.

The known conventional production methods are characterized by a large number of individual operations, during which multiple different machines or machine parts have to interact in concert. A conventional production method can comprise the following operations, for example:
1) filling the die with a metal oxide powder using a filling device
2) filling in tablet material using a stirring mechanism
3) pressing on the tablet material
4) optically measuring the fill level in the die
5) cyclically stamping round disks out of a wire strip by way of a stamping station, wherein the stamped-out disks fall onto the surface of the tablet material within the die
6) optically and/or electrically checking whether the round disks, which are used as the supporting meshes, are inserted into the die bore
7) pressing process
8) ejecting process
9) sorting out flawed pellets, wherein flawed pellets, which do not contain a supporting mesh, for example, can be recognized from their low weight, for example
10) removing the “good” pellets from the production machines, for example using a discharge chute, wherein the production machines typically operate cyclically.

Due to the complexity of this method, production shutdowns and failures frequently occur and the entire production method is very monitoring-intensive. Furthermore, only very low production performances of, for example 10 to 20 pellets per minute are achieved using the known, conventional production methods, which is a very low value in comparison to pellets without supporting meshes.

A device for transferring, inserting, and positioning films in dies of tablet presses is known from EP 2823 799 A1. Chips, which can monitor, regulate, or control physiological processes, can be embedded in the films. The films are preferably provided prefinished with corresponding carrier strips and individually packaged for acceptance in the device by means of one or more rolls. In an alternative embodiment, the films are supplied by means of one or more film trays and stamped out of the film tray and moved into an acceptance position before being provided. The films can preferably be flexible or yielding and can be produced from soluble materials, for example, so that the films dissolve in the stomach or intestinal tract.

One advantage of the device of EP 2823 799 A1 is the possibility of reliably and automatically introducing such sensitive films having chips into tablets. The films are not suitable, however, as supporting meshes for stabilizing pellets which comprise, for example, metal oxide powder and have a high level of residual moisture, so that they can easily be damaged or fall apart without support. A person skilled in the art would also not have any suggestion proceeding from EP 2823 799 A1 of using the device for stabilizing fragile pellets or modifying the device in such a way that it is suitable for such a use.

It is accordingly the object of the present invention to provide a device and a method for producing pellets from a metal oxide powder having a high level of residual moisture, which do not have the disadvantages and deficiencies of the prior art. In particular, the produced tablets are to have a high level of mechanical stability and strength, but high production performances are nonetheless to be achieved. The devices for producing the pellets are to be easy to operate and low maintenance. Furthermore, they are to be able to be used or refitted for various purposes. The production method to be provided is to enable a high production performance and is to be resistant to faults at the same time. In addition, relatively large pellets, for example having a diameter of 10 to 22 mm and a height of 0.5 to 3 mm, are to be able to be produced in an uncomplicated and stable manner using the method to be provided and the device to be provided.

### DESCRIPTION OF THE INVENTION

The object is achieved by the features of the independent claims. Advantageous embodiments of the invention are described in the dependent claims. According to the invention, a device is provided for providing supporting meshes for use as inserts in a pellet on a tablet machine. The device is characterized in that it comprises a stamping unit and a transport unit having carriers, wherein the stamping unit is designed to stamp the inserts out of a strip-shaped material, wherein the strip-shaped material is preferably a wire mesh strip, and to transfer them to the carriers of the transport unit, wherein the stamped-out inserts are transported on the carriers to a transfer unit, wherein the transfer unit is designed to accept the stamped-out inserts from the carriers and insert them into openings of a die plate of the tablet machine, so that they form supporting meshes, which are processable by the tablet machine with a tablet material to form a pellet having insert. The processing of the inserts or the production of the pellets preferably takes place using pressing tools of the tablet machine, which are preferably formed by upper and lower punches.

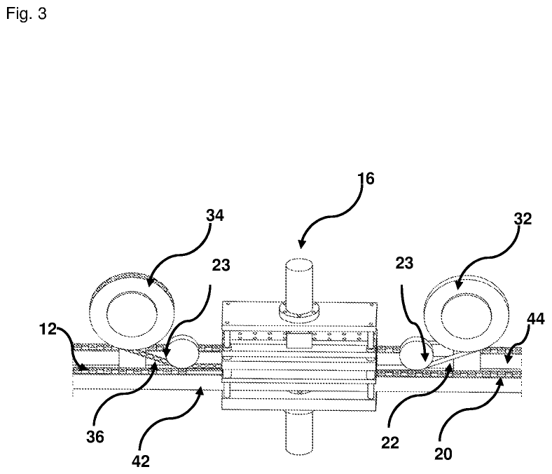

It is preferred in particular in terms of the invention that the transport unit comprises carriers, wherein the carriers are designed to transport the stamped-out inserts. The carriers are preferably formed by metallic cylinders, which can be designed, for example, as hollow cylinders or as solid cylinders having a central longitudinal bore. It can also be preferable in terms of the invention that the carriers comprise plastic or are formed from plastic. The hollow cylinders are preferably also referred to as cylindrical bodies. The central bore within the hollow cylinder can also be embodied, for example, as a center bore. It is preferred in terms of the invention that a compressed air blast or a vacuum can be applied to the guide of the carrier through the longitudinal bore or through the cavity within the hollow cylinder. In other words, it is preferred in terms of the invention that the inserts, which preferably come to rest centered on the guides of the carriers after the stamping, can be suctioned on using a vacuum and thus removably fixed on the carrier, or its guide, or that the inserts, when they are to be inserted into the opening of the die plate in the region of the tablet machine, can be ejected using a compressed air blast. The guides can be, for example, notches, openings, holes, or depressions in an upper region of the carrier or its surface. In addition to the guide, the carriers can furthermore have an outer terminus ring on their upper side, which preferably ensures that the stamped-out inserts located on the carriers do not slip or are undesirably separated from them. Exemplary embodiments of the upper sides of the carrier are shown, for example, in FIGS. 3, 4, and 5. It is preferred if the carriers consist of stainless steel, so that they stand stably on the transport belt with the required weight. The carriers can also comprise inserts made of plastic, wherein this is preferably FDA-approved plastic.

It represents a special advantage of the invention that a system made up of a proposed device and a conventional tablet machine can be provided, in which continuously and cyclically operating elements cooperate with one another in an uncomplicated manner. The invention thus overcomes the prejudice existing in the technical world that this is not possible or is only possible with great technical difficulties. The invention therefore in particular represents a departure from the prior art, wherein the uncomplicated interaction of cyclic insert feed and continuous pellet production by the tablet machine is enabled in particular by the synergistic interaction of the components of the proposed device. For example, the stamping unit provides inserts cyclically, for example 10 inserts per work step. The design of the transport unit and the transfer unit or their interaction enable a transfer without problems of the inserts to the tablet machine, which preferably operates continuously. For example, the tablet machine can be a rotary press, in which pellets are produced in the openings of a die plate, wherein the die plate is, for example a component of a rotor.

It is preferred in terms of the invention that the inserts can be produced by means of the stamping unit from a strip-shaped material, preferably a wire fabric, preferably in that they are stamped out of the strip-shaped material. The strip-shaped material is preferably also referred to as a starting material in terms of the invention. It can preferably be a metal foil made of a wire fabric or a wire mesh strip, wire mesh strip preferably means a strip-shaped material made of a metal mesh, preferably a metal wire arranged in a mesh shape. The wire mesh strip can be, for example, a strip-shaped wire fabric or wire mesh, which refers to formations preferably made of metal and are provided with identical openings in a regular arrangement. Wire fabrics can be produced, for example, by perpendicular crossing of warp and weft wires made of metal on looms. Any mesh structures, preferably made of metal, are to be included by the concept of a wire mesh strip, which are characterized by periodic openings and struts and thus give the pellet a high level of stability with low material usage.

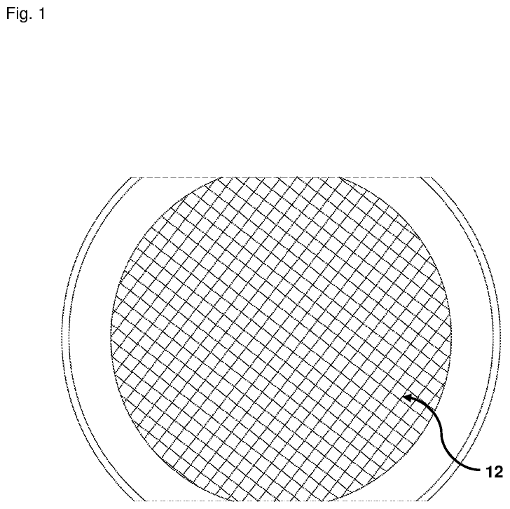

It is very particularly preferred in terms of the invention that objects can be produced by the stamping process, which is carried out by means of the stamping unit for use as inserts in tablets or pellets, in particular supporting meshes, which are designed to improve the mechanical stability of such pellets, which would easily fall apart or break apart without the addition of stabilizing additives and thus could only be further processed with difficulty or not at all using the typical means. An exemplary embodiment of an insert which is formed by a supporting mesh is shown, for example in FIG. 1. It is preferred in terms of the invention that the supporting meshes are preferably also referred to as wire mesh, mesh oblates, mesh rounds, stamped-out inserts, mesh disks, and/or metal mesh. The supporting meshes can be stamped out of a strip-shaped provided starting material, preferably a wire mesh strip, wherein the structure of the inserts can be defined by stamping tools of the stamping unit. It is preferred in terms of the invention that the supporting meshes comprise a wire fabric or wire mesh made of metal or are formed therefrom. The wire fabric can in particular comprise stainless steel 316L or can consist thereof. Any corrosion is thus advantageously avoided particularly effectively, which can be desirable above all in view of the increased residual moisture of the tablet material to be compressed comprising a metal oxide powder, for example manganese dioxide.

The width of the strip-shaped material preferably correlates with the diameter of the pellets to be produced. It is preferred in particular in terms of the invention that the starting material, before it is fed to the stamping unit, is provided on a feed roll or a supply roll. Such a roll is preferably also referred to in terms of the invention as “means for supplying” or as a “roll having fresh wire fabric”.

In one preferred embodiment, the device comprises means for supplying the strip-shaped material and means for receiving a stamped-out strip-shaped material.

The means for supplying the strip-shaped material preferably comprise a feed roll, on which a strip-shaped wire fabric is provided rolled up, and a first holding-down unit for providing the strip-shaped material for the stamping unit at a suitable height. It can also be preferred that the means for receiving a stamped-out strip-shaped material include a receiving roll and a second holding-down unit for accepting the stamped-out strip-shaped material from the stamping unit at a suitable height.

By means of the described components, a particularly efficient feed of a wire mesh strip to the stamping unit is possible, which may be integrated without errors into an automated process and thus ensures high production rates with a high quality standard.

The proposed device therefore preferably comprises, in addition to the stamping unit and the transport unit, a material unit which is preferably designed to supply the strip-shaped material in the region of the stamping unit and to transport the remainder of the strip-shaped material which remains left over after the stamping process out of the stamping unit and thus to keep it so that disturbances do not occur within the production process for the pellets. It is preferred in terms of the invention also to refer to the remainder of the strip-shaped material preferably as “waste”, “stamped-out strip-shaped material”, or “remaining material”. The material unit preferably also comprises, in addition to the means for supply, means for receiving the remainder of the strip-shaped material. These receiving means can preferably also be referred to as a waste roll or receiving roll. In other words, it is preferred in terms of the invention that the device, in particular a material unit, which can preferably be associated with the stamping unit and is arranged in spatial proximity thereto, comprises means for supplying the strip-shaped material and means for receiving the stamped-out strip-shaped material.

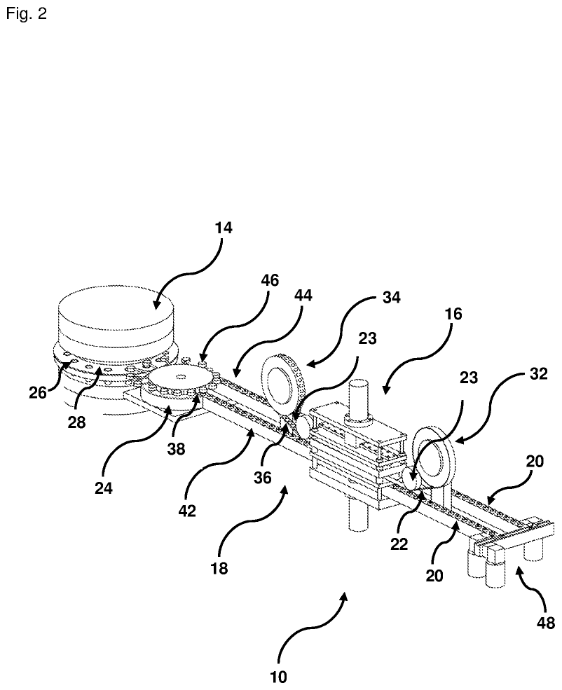

It is preferred in terms of the invention that the means for supplying and the means for receiving the waste are each provided on one side of the stamping unit. It is furthermore preferred that a tensioning roll is provided arranged as a holding-down unit in each case between the stamping unit and the means for supply and/or the means for receiving. The holding-down units are preferably designed to provide the starting material for the stamping unit at a suitable height, so that the material can be processed in a particularly easy and uncomplicated manner by the stamping unit to form supporting meshes. In the direction of the material transport, a possible sequence of optional and facultative apparatuses of the invention can read as follows: feed roll, first tensioning roll for holding down the starting material, stamping unit, second tensioning roll for holding down the residual material, receiving roll, transfer unit, tablet machine, wherein sections of the transport belt of the transport unit can be provided arranged between the individual apparatuses. An exemplary embodiment of the invention is shown in FIG. 2; an exemplary embodiment of the material unit is shown in FIG. 3.

A mesh in terms of the invention preferably represents an arrangement of elongated components at uniform intervals. The grids which are used in the context of the present invention as supporting meshes to increase and improve the mechanical stability of otherwise unstable pellets preferably have an essentially circular footprint and are formed flat. A flat, i.e., planar embodiment preferably means in terms of the invention that the height of the supporting mesh is very small in comparison to its diameter. The preferred supporting meshes can preferably have 20 to 25 mesh rods in the two spatial directions which the mesh plane spans. It is preferred in terms of the invention to use the terms “elongated components” and “mesh rods” synonymously. The structure of the supporting mesh is preferably predetermined by the design of the stamping means, which can preferably also be referred to in terms of the invention as stamping punches or stamping tools. For example, the regions of the supporting mesh at which material is stamped out, which are thus absent in the supporting mesh, can be induced by elevations on the upper side of a stamping means, while the mesh rods correspond to depressions on the upper side of the stamping tools. It is preferred in particular in terms of the invention that the supporting meshes are produced without edges. A preferred diameter of the supporting meshes is approximately 10 to 22 mm, wherein these diameters correlate to the desired diameters of the pellets to be produced. It is preferred in particular in terms of the invention that the diameter of the supporting mesh is approximately 0.1 mm smaller than the diameter of the pellets. The wording that the preferred diameter of the supporting meshes correlates with the desired diameters of the pellets to be produced is therefore not unclear to a person skilled in the art, but rather a person skilled in the art infers from this wording that this means that the diameter of the supporting mesh is approximately 0.1 mm smaller than the diameter of the pellets. It can also be preferred for other applications that the deviations between the diameters of the supporting meshes and the pellets are greater or less than 0.1 mm.

It is preferred in terms of the invention that the stamping unit comprises a number of N stamping means, wherein the stamping means are designed to stamp the inserts as supporting meshes out of the strip-shaped material.

It is preferred in terms of the invention that the stamping process takes place in stamping dies. The stamping dies comprise openings into which the stamping tools can be introduced and in which the supporting meshes are stamped out of the starting material. The number N of the stamping means is preferably in a range of 1 to 50, preferably of 3 to 20, particularly preferably of 5 to 15, and most preferably 10 stamping tools. In particular all values and integers between 1 and 50 are preferred.

In one preferred embodiment, the stamping unit is designed to stamp out the inserts as supporting meshes having a circular footprint from the strip-shaped material, wherein the inserts preferably have a diameter of 10 cm to 22 cm. For this purpose, for example, the stamping matrices can be dimensioned accordingly. The inserts are preferably dimensioned by means of the stamping unit so that they essentially correspond to the shape or surface of the pellets or are slightly smaller, for example with respect to a diameter around a tolerance range of 0.02 mm to 1 mm, preferably 0.05 mm to 0.2 mm, particularly preferably approximately 0.1 mm smaller. A particularly reliable stabilization of the pellets may be achieved using supporting meshes dimensioned in this way.

It is very particularly preferred in terms of the invention that the stamping unit operates cyclically. A cyclic operating mode means in terms of the invention that the work of the stamping unit, i.e., the production of the supporting meshes, takes place in work steps separate from one another, wherein, for example 10 supporting meshes can be produced during each work step. The number of grids produced per work step preferably correlates with the number of the stamping punches of the stamping unit. For example, 10 supporting meshes can be stamped out of the starting material per work step using a stamping unit which comprises, for example 10 stamping punches. It is furthermore preferred that the stamped-out supporting meshes are transferred in groups of, for example 10 supporting meshes to the transport unit, in particular its carriers, or are accepted thereby.

It represents a particular advantage of the invention that a device can be provided, using which a cyclic provision of supporting meshes can be brought into harmony with a continuously operating tablet machine. This is advantageously achieved in particular by the operating mode of the transport unit in conjunction with the transfer unit of the device, or in that the work of the preferably continuously producing tablet machine is independent and decoupled from the work of the proposed device, which comprises the stamping unit, the transport unit, and the transfer unit. The components of the proposed device advantageously do not engage in the operating mode of the tablet machine, so that a conventional tablet machine can be used to execute the proposed method and in the context of the present invention. For example, a conventional rotary press can be used for this purpose. It can be preferred in particular in terms of the invention to equip or retrofit existing facilities in a battery or button cell factory with the proposed devices in order to achieve an increase of the production performance. It can thus be preferred in particular to equip newly produced tablet machines with the proposed device or to retrofit existing tablet machines with the proposed device. The economic significance of the present invention thus increases, since the proposed device can be used very flexibly.

The stamping unit is designed to transfer the inserts to the carriers of the transport unit. It is preferred in terms of the invention that carriers are located below the stamping dies during the stamping process, wherein the number of the carriers preferably corresponds to the number of the stamping means. It is preferred, for example that the number of the stamping tools and the number of the carriers is each 10. It is preferred in terms of the invention that the carriers are raised by a height difference Δh in relation to the normal height of the transport belt of the transport unit during the receiving of the supporting meshes. It is preferred in terms of the invention that a lift of the carriers from the transport device to below the stamping matrices can be, for example 10 to 20 mm. In other words, a height difference Δh between the transport device to below the stamping matrices preferably of 10 to 20 mm is preferred.

The raising of the carriers in the region of the stamping unit can preferably be carried out using a lifting apparatus. In other words, it is preferred in terms of the invention that the carriers can be raised using a lifting apparatus in the region of the stamping unit. It is furthermore preferred that the lifting apparatus comprises a drive, wherein this drive is designed to raise the lifting device and the carriers which are located in a region of action of the lifting device. The region of action of the lifting device can coincide, for example, with an interior of the stamping unit, i.e. the carriers are raised using the lifting device in particular within the stamping unit.

The stamping unit can furthermore comprise a drive for the stamping means, wherein the drive for the stamping means is designed to move the stamping means downward. It is advantageously possible by way of this movement of the stamping means to stamp the inserts out of the supplied strip-shaped material. The stamping means are preferably moved downward by the drive for the stamping means, wherein the wording “downward” in terms of the invention preferably means that the stamping tools are moved by their drive from an upper region of the stamping unit in the direction of a lower region of the stamping unit. It is preferred in terms of the invention that the strip-shaped starting material, from which the supporting meshes are stamped out, is introduced into the stamping unit between the carriers and the stamping punches moving downward from above. In that the stamping punches, preferably driven by the corresponding drive means and at high speed, enter the stamping dies, the supporting meshes are produced on and detached from the starting material, so that they fall onto the carriers of the transport unit, which are arranged below the supplied starting material. It is preferred in terms of the invention that the drive for the stamping means is provided attached above the stamping unit.

After receiving the supporting meshes, the carriers are preferably lowered back to the typical height level of the transport belt of the transport unit and the inserts are transported using the transport unit, in particular the carriers, to the transfer unit. It is in terms of the invention that the transport of the carriers within the transport unit is interrupted during the stamping process, but is continued after the acceptance or receiving of the supporting meshes by the carriers.

It is preferred in terms of the invention that of the, for example 200 carriers of the transport device, 170 to 180 are in motion. The carriers which are located inside the stamping unit are preferably at rest. It can also be preferred in terms of the invention that the carriers which are empty and are moving toward the stamping unit are also idle and stop in front of the stamping unit before their loading with stamped-out inserts. The waiting empty carriers, for example in a group of 10 carriers, preferably move for loading into the stamping unit as soon as the previously loaded carriers have been lowered to the height level of the transport unit and accepted thereby.

It is preferred in terms of the invention that the carriers are designed to transport the stamped-out inserts to the transfer unit, wherein the transfer unit is designed to accept the stamped-out inserts from the carriers. In other words, it is provided that the stamped-out supporting meshes are accepted or received from the carriers by means of the transfer unit in order to be inserted into openings of a die plate of the tablet machine. The openings of the die plate of the tablet machine can preferably also be referred to as bores within a die or die plate.

It is preferred in terms of the invention that the transfer unit includes transfer means for accepting the stamped-out inserts from the carriers and for transferring the stamped-out inserts into the openings of a die plate. The transfer means can preferably also be referred to as transfer arms. It is very particularly preferable that the feed of the stamped-out inserts to the tablet machine takes place continuously. The transfer arms can preferably be provided in an extended and in a non-extended state.

The transfer unit preferably comprises a gear rim, which is provided arranged below the transfer means and is designed to accept the carrier from the transport unit or a first transport belt section of the transport unit and to transfer it past the die plate of the tablet machine to the second transport belt section of the transport unit. In other words, the carriers can be accepted using the gear rim from the transport unit, in particular the first transport belt section of the transport unit, and transferred to the second transport section of the transport unit. It is preferred in terms of the invention that the first transport section represents the path of the carriers to the tablet machine or to the transfer unit, while the second transport section represents the return path of the carriers from the transfer unit. The first and the second transport belt section are preferably formed essentially in parallel to one another.

The transport unit is preferably formed essentially similar to an ellipse, wherein the long sides of the transport unit formed essentially similar to an ellipse are preferably formed essentially in parallel and are referred to as the first and second transport belt section. The loaded carriers are preferably transported on the first transport section toward the tablet machine and the empty carriers are transported on the second transport section away from the tablet machine. Preferably, the first transfer unit forms a first outer point of the transport unit, while a preferably opposing reversal position or such a reversal point can form a second outer point of the transport unit. It is preferred in terms of the invention that the transport unit comprises between 50 and 500, preferably between 100 and 400, particularly preferably between 150 and 250, and most preferably approximately 200 carriers, wherein any integer between 50 and 500 can be preferred.

It is preferred in terms of the invention that the transport unit comprises a circulating transport belt which is formed from transport sections. In particular, the transport unit preferably comprises a first transport belt section and a second transport section, which are preferably formed essentially in parallel to one another, wherein the first transport belt section forms the path of the loaded carriers from the first outer point of the transport unit to the transfer unit and the second transport belt section forms the return path of the empty carriers from the transfer unit to the first outer point of the transport unit. In other words, it is preferred in terms of the invention that the transport unit comprises two essentially parallel transport sections, wherein the stamping unit is provided arranged in a first transport section or is associated with it.

It is particularly preferred in terms of the invention that the gear rim of the transfer unit accepts the carriers automatically in succession and guides them past the rotor of the tablet machine, which comprises the die plate, for example. It is preferred in terms of the invention that the transfer means includes heads, wherein the heads of the transfer device can be adjusted axially and/or in height using the transfer arms. When the carriers are provided docked on the transfer unit, in particular the gear rim of the transfer unit, the heads of the transfer device are preferably located centrally above the carriers and thus preferably also centrally above the stamped-out inserts, in particular the supporting meshes.

It is preferred in terms of the invention that the transfer means have transfer heads in a front region, wherein the transfer heads have openings on their lower side to which a vacuum or compressed air can be applied. The transfer heads can therefore preferably also be referred to as vacuum heads or suction heads. The transfer unit can comprise arms, control curves, compressed air fittings, and/or vacuum fittings for the control and movement of the transfer heads, wherein the vacuum heads are in particular designed so they can be displaced and/or lowered and can plunge into the carrier centering device and/or into the dies of the tablet press. The vacuum heads are preferably designed to accept the inserts from the transport unit or its carriers. Furthermore, the vacuum heads are embodied to be controllable, wherein the control of the vacuum heads is preferably carried out using suitable control means, for example control curves.

It is preferred in terms of the invention that the transfer means are designed to accept the stamped-out inserts from the guides and/or centering devices of the carriers, wherein this acceptance preferably takes place in the non-extended state of the transfer means. For this purpose, the heads of the transfer means are preferably located centrally above the carriers or above the guides of the carriers. It can be preferred in terms of the invention that at the moment of the transfer, a possible vacuum, using which the stamped-out inserts are held in the guides of the carriers is switched off, and/or that the separation of the stamped-out inserts from the guides of the carriers is facilitated using a compressed air blast. It can thus also be preferred that a vacuum is applied to the heads of the transfer means at the moment of the transfer in order to fasten the stamped-out inserts on the heads of the transfer means or to facilitate the receiving of the inserts. It is preferred in terms of the invention that the transfer means are extended after completed acceptance or receiving of the stamped-out inserts, so that they are preferably provided in an extended state. It is preferred in particular in terms of the invention that the transfer means are extendable to a working length or can be extended to a working length. The transfer means preferably move in the extended state or during the extension with the stamped-out inserts in the direction of the tablet machine or in the direction of the pitch circle of the die plate or its openings.

In a further aspect, the invention relates to a system comprising a described device and a tablet machine, wherein the device is designed to provide supporting meshes for use as inserts in a pellet and to transfer them to the tablet machine.

The tablet machine can preferably be a rotary press as is generically known from the prior art. In this case, a rotor preferably includes an upper and lower punch guide for receiving punches, so that powdered material is compressed to form a pellet or a tablet in the cavities or openings of a die plate under interaction of upper and lower punches.

A person skilled in the art recognizes that preferred embodiments which were disclosed in conjunction with the device apply similarly to the system comprising a tablet machine and the device and result in the described advantageous effects.

In one preferred embodiment, the tablet machine comprises a die plate, wherein the system is designed so that a movement of the transfer means of the device takes place synchronously with a movement of the die plate of the tablet machine.

In a further preferred embodiment, the system is characterized in that the transfer unit is designed so that transfer means pass over a pitch circle of the die plates of the tablet machine in an extended state.

It is preferred in terms of the invention that the transfer means is designed so that the transfer means pass over a pitch circle of the die plate of the tablet machine in an extended state. The transfer unit and the length and design of the transfer means are provided so that there is a significant overlap between the transfer means and the die plate.

It is very particularly preferred that the transfer means move over a pitch circle of the die plate in the extended state. It is preferred in terms of the invention that a size of this pitch circle can be defined by a value in degrees of angle. It is preferred in terms of the invention that the overlap angle is in a range between 60 and 90°. In terms of the invention, this preferably means that the pitch circle on which the transfer heads also move over the die plate is formed by a circle sector which has an opening angle of 60 and 90°.

Furthermore, it is very particularly preferred that the heads of the transfer means move for a time period Δt essentially above the openings of the die plate, so that the stamped-out inserts, when any possible vacuum which can be applied to the heads of the transfer means is switched off, can fall into the openings of the die plate. It is very particularly preferred in terms of the invention that due to a synchronization of the transfer means with the movement of the die plate, the heads of the transfer means follow the pitch circle of the die plate over which the transfer arms pass. It is preferred in terms of the invention that a movement of the transfer means takes place synchronously with a movement of the die plate. The movement of the transfer means and the movement of the die plate of the tablet machine are preferably synchronized, i.e., matched with one another. The synchronization of the movements of the transfer means and the die plate of the tablet machine provides a significant contribution to the particularly accurate positioning of the supporting meshes in the die openings.

It is additionally preferred that the rotational velocity of the transfer unit is settable variably and synchronously with the rotor velocity of the tablet machine. It is preferred in terms of the invention that the transfer unit accepts the inserts from the transport unit. The transfer unit is capable due to the vacuum heads of suctioning on the inserts from the carriers. Due to the preferably essentially identical rotational velocity of the transfer unit and of the rotor of the tablet machine, a controllable transfer of the inserts into the die openings of the tablet machine can take place. The preferably essentially identical rotational velocity of the transfer unit and the rotor of the tablet machine is preferably also referred to in terms of the invention as synchronous operation of the transfer unit and the tablet machine. The precision and reproducibility with which the inserts are individually insertable into the die openings of the tablet machine were surprising. Surprisingly, for example, conventional tablet machines could cooperate with the present invention. The invention is thus usable in a variety of ways and can be adapted individually to greatly varying requirements, for example with respect to throughput and speed.

It represents a particular advantage of the present invention that due to the interaction of the proposed device with the tablet machine, such a large overlap between the transfer means and the die plate can be achieved that a particularly precise and reliable transfer of the inserts into the die openings is ensured. In particular, it was surprising that the overlap can be achieved for such a large range of degrees of angles. A relatively long time span Δt for the transfer of the stamped-out inserts into the die openings thus results, so that particularly precise positioning of the stamped-out inserts in the die opening is enabled. The number of flawed pellets can thus be reduced to a minimum.

In one preferred embodiment, the system is characterized in that the tablet machine comprises a die plate having openings and the stamping unit is designed to stamp the inserts out of the strip-shaped material as supporting meshes having a footprint which is nearly congruent with the openings.

In terms of the invention, an opening of the die plate preferably refers to a cavity within a die plate into which pressing material is introduced, in order to then be compressed to form a pellet by an interaction of the upper and lower punches. The cavities or openings can be formed in the die plate in various ways. For example, it can be preferred that die bores, which form the openings, are provided in a possibly segmented die plate. Recesses for separate die inserts can also be provided in the die plate, wherein the die inserts have openings or cavities in the form of die bores. The cross section of the openings can be different depending on the desired shape of the pellets. For example, the cavities can preferably be circular, rectangular, triangular, star-shaped, ellipsoidal, oval, or also can assume other shapes. The shape is preferably circular.

Nearly congruent preferably means that the inserts have an identical shape and an identical or only slightly smaller cross-sectional area. For example, the cross-sectional area of the inserts can be smaller by less than 20%, preferably less than 10%, preferably less than 5% in the cross-sectional area of the openings. In this way, supporting meshes are provided which nearly completely cover the surface of the pellets and therefore stabilize them to a special extent.

Terms such as essentially, approximately, about, circa, nearly, etc. preferably describe a tolerance range of less than ±20%, preferably less than ±10%, even more strongly preferably less than ±5%, and in particular less than ±1%. Specifications of essentially, approximately, about, circa, etc. always also disclose and comprise the exact mentioned value.

A precise positioning, as can be achieved using the proposed invention, is important above all if the inserts are only slightly smaller than the openings of the die plate or the diameters of the pellets. Since in particular also larger pellets, for example having diameters between 10 and 22 mm, can also be compressed using the proposed method and using the proposed device and an optimum stability improvement is achieved in particular in these pellets if the inserts are only slightly smaller than the openings of the die plate, pellets which comprise manganese dioxide, for example, can be produced and further processed particularly well using the proposed method. It is preferred in terms of the invention that the inserts have a diameter smaller, for example, by 0.02 mm to 1 mm, preferably 0.05 mm to 0.2 mm, particularly preferably approximately 0.1 mm than the pellets which are produced using the present invention.

In one preferred embodiment, the system is characterized in that the tablet machine comprises a die plate having die holes and the stamping unit is designed to stamp out the inserts from the strip-shaped material as supporting meshes having a circular footprint, wherein the inserts have a diameter which is smaller by 0.02 mm to 1 mm, preferably 0.05 mm to 0.2 mm, particularly preferably approximately 0.1 mm than the diameter of the die holes.

It can also be preferred in terms of the invention that the heads of the transfer means are lowered entirely or partially into the openings of the die plate before the inserts are deposited on the tablet material within the die holes. The stamped-out inserts are then processed by the tablet machine with a tablet material to form a pellet including an insert, in particular a supporting mesh.

In a further aspect, the invention relates to a method for producing a pellet which includes an insert. The proposed method comprises the following steps:
a) providing a strip-shaped material (by means for supply, feed roll, supply roll) to a stamping unit
b) stamping out inserts from the strip-shaped material in the stamping unit
c) transporting the stamped-out inserts to a transfer unit
d) transferring the stamped-out inserts using (transfer means) of the transfer unit into openings of a die plate of a tablet machine
e) producing a pellet which includes an insert.

The definitions, technical effects, and advantages described for the proposed device or system apply similarly to the proposed method. In addition, it is preferred that the proposed method can be executed using the proposed device or using a system comprising a tablet machine and the proposed device. The features which are described for the invention can preferably be combined with one another as desired and the features can be essential to the invention in any combination. In particular, the features described for the device are also considered to be disclosed in conjunction with the proposed method, and vice versa.

It is preferred in terms of the invention that the stamping out of the inserts takes place cyclically, while the feed of the stamped-out inserts to the tablet machine takes place continuously. It is preferred in terms of the invention that the provision of the strip-shaped material can take place by means of a feed roll or supply roll, wherein these rolls are preferably referred to as “means for supplying” the strip-shaped material. The rolls can be associated with a material unit which is a component of the device, in particular the stamping unit. It can furthermore be preferred that the stamping out of the inserts is carried out by stamping means which are preferably components of the stamping unit. The inserts are preferably supporting meshes for the mechanical stabilization of pellets. It is very particularly preferred that the tablet material to be compressed can preferably be “moist” metal oxide powder, in particular manganese oxide powder. It is very particularly preferred that manganese dioxide powder having a relatively high residual moisture can be compressed using the proposed method and the proposed device, wherein the residual moisture originates, for example from preceding chemical treatments. However, it can also be preferred to compress other materials, in particular those which are suitable for producing cathodes of button cells, using the proposed method and the proposed device. The obtained pellets preferably have a diameter of 10 to 22 mm and a height of 0.5 to 3 mm. It is furthermore preferred that the stamped-out inserts have a diameter which is, for example 0.1 mm smaller than the diameter of the pellets. The transport of the stamped-out inserts to the transfer unit can preferably comprise the following further method steps:
c1) providing carriers by way of a transport unit
c2) receiving the stamped-out inserts by way of the carriers in the stamping unit.

It is particularly preferred in terms of the invention if the provision of the carriers by the transport unit takes place inside the stamping unit, i.e., if the carriers are provided in the stamping unit. The stamped-out inserts are preferably also accepted by the carriers of the transport unit within the stamping unit.

In one preferred embodiment of the invention, the method is characterized in that the transfer of the inserts into openings of the die plate of the tablet machine takes place after filling of a pressing material into the openings, so that during subsequent compression, the inserts are pressed as supporting meshes into the surface of the pellet and stabilize the pellet. In this way, the supporting meshes are preferably laid on a preferably already completely prefilled die, wherein the pressing material located in the opening is pressed to a desired pellet height with the supporting mesh resting on top by means of upper and lower punches. This permits a particularly stable connection of the supporting mesh to the pellet and results in break-proof pellets which can be further processed.

In one preferred embodiment, the production of the pellet with the inserts in the tablet machine, i.e., preferably the pressing process, is followed by a heat treatment for drying, wherein the heat treatment preferably takes place over a time period of more than 6 hours, preferably more than 12 hours. For example, temperatures of greater than 30° C., greater than 40° C., or greater than 50° C. can be preferred for this purpose. In particular in the case of a pressing material comprising metal oxides, preferably manganese dioxide, outstanding results can be achieved in this case for a reliable connection having long-term stability of supporting mesh to pressing material.

The invention is described in the following by examples and specific embodiment options: The invention can advantageously be used in the production of lithium-manganese dioxide round cells. In contrast to the manufacturing of silver oxide button cells, lithium batteries are constructed differently, so that different demands are also placed on individual components. The manganese dioxide is preferably subjected to a special chemical treatment and fed having a relatively high level of residual moisture to the rotary press, in which the manganese dioxide powder is pressed into a round disk. Due to the relatively large diameter, the low thickness, and the relatively high level of moisture, the tablets disadvantageously do not have a high strength or tablet hardness. The tablets are very sensitive in this state and usually cannot be transported to the further production stations without damage.

In order to implement automated, effective manufacturing using these sensitive tablets, the tablets have to be stabilized with the aid of a “supporting corset”. This supporting corset can be a thin wire mesh, which is laid on the surface of the pressing material as a round disk, preferably after the filling of the dies of a rotary press and before the compaction of the powder. The pressing process is then carried out, for example, by the prepressure station and/or main pressure station of the rotary press, wherein the pressing material located in the die is pressed with the round wire mesh resting on top to the desired pellet height by means of the upper and lower punches. In this case, the wire mesh is pressed into the surface of the pellet, whereby it is intimately connected to the pressing material and thus stabilizes the pellet. It is preferred in terms of the invention that the finished tablets are subjected to a 24-hour heat treatment after the pressing process having the pressed-in wire mesh. The manganese dioxide pressing compound dries out and hardens in this case, so that a very stable connection has now resulted between the pellet and the supporting mesh. The pellet thus stabilized can thus be transported without damage through the following process stations.

It is preferred in terms of the invention that the proposed device comprises a stamping unit which is equipped, for example, with 10 stamping tools. The stamping unit or a material unit associated with it can preferably comprise a holding-down unit for the mesh strip, a roll having the fresh mesh strip, and a roll having the stamped-out waste strip, as well as roll drives. During the stamping process, for example 10 carriers are located raised below 10 stamping dies, for example, which can receive the stamped-out mesh disks. After the 10 carriers are filled with the mesh oblates, the carriers are lowered back to the height of the transport unit and fed by the transport unit to a transfer device, which is located in spatial proximity to a rotary press, for example. The gear rim located below the movable vacuum arms is preferably designed to automatically accept the carriers in succession in order to feed them to the rotor of the rotary press or guide them past the rotor. When the carriers are docked on the transfer device, the heads of the transfer arms are preferably located centrally above the stamped-out mesh rounds, which rest in the guide and/or a centering device of the carriers. On the path to the die plate, the heads are lowered and a vacuum can be activated, which attracts the stamped-out mesh disks. Before the transfer heads reach the pitch circle of the dies of the rotary press, the heads are raised and extended to the working length. The pitch circles of the die plate and the transfer heads advantageously significantly overlap. Due to a synchronization of the arms with the die plate, the heads follow the die pitch circle over the length of the overlap. At this time, the heads are lowered and the vacuum is switched off when the lower part of the head is within the die hole, so that the stamped-out mesh falls onto the preferably precompacted and flattened pressing material. This process is possibly also assisted by a brief compressed air pulse.

The tablet machine which is used in conjunction with the proposed device or to carry out the proposed method can preferably be a rotary press. The rotary press is preferably designed for the following operations or comprises the following functional units:
1. filling device for the manganese dioxide powder
2. pressing station
3. transfer device
4. optical check as to whether the insert, in particular the supporting mesh, is inserted
5. pre-compaction
6. main compaction
7. ejection of the pellets
8. sorting out of faulty pellets, recognizable, for example from missing inserts or low weight of the pellet
9. transporting away the “good” pellets

The rotary press is preferably connected using an essentially ring-shaped transport systems for the carriers to the stamping unit. For example, 200 carriers are located in permanent circulation. The stamping unit carries out, for example 20 stamping processes per minute, so that the rotary press can produce 200 pellets made of manganese dioxide powder having a pressed-in supporting mesh per minute. A rotary press having, for example 29 pressing tools is thus higher performance by a factor of 10 to 20 times than the conventional cycled systems which are known in the prior art. If a double rotary press having a greater number of pressing tools is used as a tablet machine, for example, the production performance can be increased further.

It is preferred in terms of the invention that the stamped-out wire mesh is similar in size to the pellet. It is preferred in particular that the diameter of the insert is, for example approximately 0.1 mm smaller than the diameter of the manganese tablets. This small size difference has the result that the transfer of the stamped-out wire mesh disk into the die filled with manganese powder has to take place extremely precisely. The present invention preferably meets this demand in that the transfer arms of the transfer unit travel along a few degrees of angle on the pitch circle of the dies and can thus ensure a precise transfer of the metal meshes into the die bore. The transfer unit preferably comprises a control unit which is designed to control the transfer of the inserts, the retraction and extension of the transfer arms, and/or the raising and lowering of the transfer arms and to match and coordinate them with the other components of the proposed device and/or the tablet machine or its movement.

A method is preferably disclosed for producing a cathode from manganese dioxide powder, for example using a rotary tablet press. The cathodes produced can preferably be used for lithium-manganese round cells having moderate and large diameter. The rotary press can be equipped with a stamping device and a transport system for carriers, and also an acceptance and transfer device, wherein the acceptance and transfer device is also referred to as a transfer device in terms of the invention. The stamping device, the transport system, and the transfer device preferably form the proposed device, which can be connected upstream of the tablet machine. Metal mesh plates can preferably be stamped-out cyclically using the stamping unit and transported using the carriers to the rotary press, wherein the metal plates are accepted from the carriers using the arms of the transfer device and continuously deposited in the filled die bores on the pressing material, in order to be compacted using the pre-pressing and/or main pressing station of the rotary press to form a composite pellet.

It is particularly preferred in terms of the invention that the produced manganese dioxide pellet is only stable enough with the wire mesh reinforcement to withstand the further mechanical work steps without damage. The diameter of the stamped-out wire mesh plate preferably essentially corresponds to the diameter of the pellet, so that the plate has to be inserted very precisely into the die. Preferably, for example 10 metal mesh plates can preferably be stamped out simultaneously using the integrated stamping unit. It is preferred in terms of the invention that, for example 10 carriers for accepting the stamped-out plates are preferably raised simultaneously by means of a central drive in order to minimize the falling height for the stamped-out inserts. The carriers can preferably be deposited back on the transport unit after receiving the plates. It is preferred in terms of the invention that the wire mesh strip is fed from a large roll to the stamp. The material and tensioning rolls can be equipped with a brake. It is furthermore preferred that a further roll winds up the stamped-out waste strip, wherein this roll is preferably provided arranged between stamping unit and transfer device in the region of the first transport belt section. The waste roll is preferably provided with a separate drive. It is preferred in terms of the invention that the material, tensioning, and waste rolls form a material unit, which can be components of the proposed device or the stamping unit. The stamped-out inserts are preferably fed using carriers to the tablet machine, wherein the transport device and the acceptance and transfer device are responsible for the transport of the carriers. It is preferred in terms of the invention that the transport unit can comprise three components, in particular a front first transport belt section, a rear second transport belt section, and a third transport belt section at the reversal point of the transport device, using which the empty carriers are transferred from the second transport belt section to the first transport belt section. This third transport belt section can preferably also be referred to as a cross transport device.

It is preferred in terms of the invention that the stamping unit operates cyclically. The stamping unit can preferably also be referred to as a stamp. It is preferred in terms of the invention that the insertion of the metal plates into the dies of the rotary press takes place continuously. The powder columns in the matrix bores of the rotor of the rotary press are preferably smoothed by a pressing station before the insertion of the wire mesh plates. In particular, the surfaces of the powder columns are smoothed. It is furthermore preferred that the powder columns are pressed with the metal plates by means of pre-pressing and/or main pressing force to form a stable composite pellet. It can preferably be determined by means of a pressing force check whether, for example the wire mesh is missing or the tablet weight does not correspond to the target value. Such flawed tablets are automatically separated from the “good” pellets and do not reach the further production process.

In particular, a method is proposed for producing a thin cathode from manganese dioxide having high moisture using a rotary press, wherein a stamp is integrated into the production method or the production device, which produces metal mesh plates cyclically from a feed roll, which are in turn continuously fed to the rotary press with the aid of carriers and are inserted using the arms of an acceptance and transfer unit into the filled die bores of the rotary press. After the tableting, this composite pellet—due to the supporting mesh—results in a significant improvement of the breaking resistance, so that the pellets withstand the further mechanical production steps without damage.

It was completely surprising that a rotary press can be provided in which the elements of the proposed device interact in such a way that a cyclic provision of the inserts by the stamping units can be converted into a continuous supply in the pressing region of a tablet machine.

The invention is described in greater detail on the basis of the following figures; in the figures:

FIG. 1 shows an illustration of a preferred embodiment of an insert

FIG. 2 shows an illustration of a preferred embodiment of a device and a rotor of a tablet machine

FIG. 3 shows an illustration of a preferred embodiment of a stamping unit and a material unit

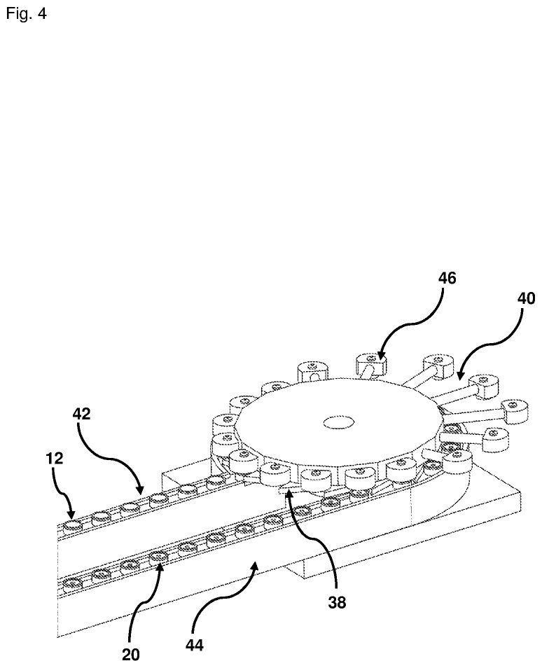

FIG. 4 shows an illustration of a preferred embodiment of a transfer unit

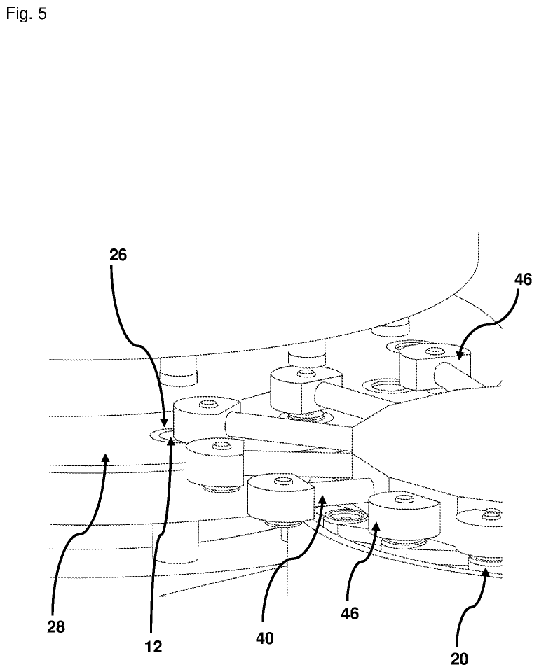

FIG. 5 shows an illustration of an exemplary transfer process of the inserts from the transport unit to the tablet machine by the transfer unit

FIG. 1 shows a preferred embodiment of an insert (12), which is located on a manganese dioxide pellet. The pellets can in particular be pellets for producing button cells, wherein such button cells are frequently used as batteries in electrical or electronic devices. A subgroup of these button cells is produced from cathodes comprising a metal oxide powder, wherein manganese dioxide is very particularly preferred as a starting material for some button cell types due to its favorable chemical properties. In particular, FIG. 1 shows a top view of a housing lower part of a lithium-manganese round cell, in which a manganese dioxide pellet having a pressed-in supporting mesh (12) is located in the middle. The pellet and the supporting mesh (12) have essentially similar diameters, which differ from one another by 0.1 mm, for example. The supporting mesh (12) is preferably formed flat and can comprise, for example 20 to 25 mesh rods in the two spatial directions which span a mesh plane. The mesh rods are symbolized in FIG. 1 by the black lines, while the tablet material is visible through the mesh openings illustrated in white. The housing of a lithium-manganese dioxide round cell is shown circularly around the wire mesh (12), in which the pellet having the supporting mesh (12) is located in the center.

FIG. 2 shows a preferred embodiment of a device (10) and a rotor (no reference sign) of a tablet machine (14), wherein the device (10) preferably interacts with the tablet machine (14) to carry out the proposed method. The tablet machine (14) is preferably not a component of the device (10), but together with the device (10) can form a system which is capable in particular of carrying out the proposed method.

The preferred embodiment of a device (10) shown in FIG. 2 comprises a stamping unit (16), a transport unit (18), and a transfer unit (24), wherein the transfer unit (24) can preferably also be referred to as a transfer device. The illustrated stamping unit (16) comprises a material unit (no reference sign), which in turn comprises a feed roll (32) for fresh strip-shaped material (22), a first tensioning roll (no reference sign) for holding down the strip-shaped material (22), a second tensioning roll (no reference sign) for holding down the stamped-out strip-shaped material (36), and a waste roll (34). It is preferred in terms of the invention that the material unit is provided in spatial proximity to the stamping unit (16).

The stamping unit (16) can comprise, for example 10 stamping punches, which stamp out the inserts (12) from the fed strip-shaped material (22) in the interior of the stamping unit (16). The strip-shaped material (22) is preferably fed using the feed roll (32). It is preferred in terms of the invention that the carriers (20) in the region of the stamping unit (16) can preferably be raised simultaneously by lifting devices until they reach the stamping dies. This preferably takes place when the preferred 10 carriers (20) are located within the stamping unit (16). The stamping means can be moved downward using a drive device, so that the inserts (12) are stamped out of the fed metal strip (22), wherein the stamped-out inserts (12) advantageously fall onto the carriers (20) or guides on the carriers (20) due to the structure of the stamping unit (16). The stamping tools preferably subsequently move back into an upper idle position, a strip holding-down unit (23) is raised, and the stamped-out strip (36) is transported in the direction of the waste coil (34) until fresh strip (22) is located under the stamping tools again. A new stamping process can then be initiated. For example, approximately 200 carriers (20) can be provided in the transport unit (18), which are preferably continuously in circulation. The stamping process takes place cyclically, the insertion of the stamped-out wire mesh disks (12) preferably takes place continuously. When the preferred 10 filled carriers (20) are deposited on the transport unit (14) in the region of the stamping unit (16), they are transported in the direction of the transfer device (24). The space below the stamping unit (16) thus becomes free and can be filled by preferably 10 empty carriers (20), which are then again loaded with preferably 10 stamped-out wire mesh plates (12). The carriers (20) loaded with the inserts (12) are transported by the transport unit (18) to the transfer unit (24). The carriers (20) are preferably accepted individually in succession there by a gear rim (38) and transported in the direction of the die plate (28) of the tablet machine (14). The non-extended or retracted heads (46) of the transfer arms (40) of the transfer unit (24) are located above the carriers (20) preferably precisely centrally above the inserts (12). During the rotation of the unit (24) in the direction of the die plate (28) of the tablet machine (14), the heads (46) can be lowered. Furthermore, a vacuum can be activated which suctions on the inserts (12) and separates them from the carriers (20). Subsequently, the heads (46) are slightly raised and extended enough that the pitch circle of the arms (40) overlaps, for example two times with a pitch circle of the die plate (28) of the tablet machine (14). The transfer unit (24) rotates synchronously with the die plate (28) of the tablet machine (14), so that the stitch spacing of the dies (26) is preferably essentially always equal to the spacing of the transfer arms (40). The transfer arms (40) are guided on the die pitch circle via a curve controller from the overlap point of the two pitch circles. Over this angle range, the transfer arms (40) are lowered and a vacuum can be switched on as soon as an insert (12) are located within the die bore (26) above the smoothed pressing material. The insert (12) thus falls on the pressing material in the opening (26) of the die plate (28). The transfer arms (40) are subsequently raised again and a new insert (12) moves on its own pitch circle to the acceptance position. The filled dies (26) now pass the pre-pressing and/or main pressing station of the tablet machine (14) and/or thus compacted to form a pellet which is stabilized by the pressed-in wire mesh (12). The pellets are subsequently ejected from the die (26). It is checked beforehand by the pressing force whether a wire mesh (12) has been inserted and whether the weight of the pellet is correct. If one of the two criteria is not met, this pellet is sorted out as a reject. The “good” pellets leave the tablet machine (14) via a transport belt or a chute. The empty carriers (20) are guided back via the second transport belt section (44) of the transport unit (18) preferably essentially in parallel to the first transport belt section (42) and conducted by a cross transport device (48) back to the first transport belt section (42), on which they are fed to the stamping unit (16) again for a new circulation. This cross transport device (48) is also referred to as a third transport belt section (48) in terms of the invention.

The transport unit (18) comprises carriers (20), wherein one particularly preferred embodiment of the invention comprises, for example approximately 200 carriers. The carriers (20) can be designed as hollow cylinders or cylinders having longitudinal bores and/or center bores. A vacuum, a negative pressure, or compressed air blasts can be applied to them in particular. The vacuum or the negative pressure can be used to suction the inserts (12) onto the carriers (20) and thus fasten them strongly and stably, but releasably on the carriers (20). The inserts (12) can be removed or released particularly easily from the carrier upper sides using the compressed air blasts. The transport unit (18) can therefore comprise fittings and/or feed and exhaust lines for the vacuum, the negative pressure, or the compressed air. The carriers (20) preferably move along transport rails, which can preferably also be designed as transport belts. In particular, the transport unit (18) comprises two essentially parallel transport sections (42, 44), wherein the stamping unit (16) is provided arranged in a first transport section (42), wherein the transport sections can preferably also be referred to as transport belt sections (42, 44). It is preferred in terms of the invention that the first transport section (42) represents the path of the carriers (20) on the way to the tablet machine (14). The transition between the second transport section (44) and the first transport section (42) is formed by a third transport belt section (48), using which the empty carriers (20) are transferred from the second rear transport belt section (44) for renewed loading at the front first transport belt section (42).

The transfer unit (24), using which the inserts (12), which are held by the transfer heads (46), can be inserted into the openings (26) of the die plate (28) of the tablet machine (14), forms the transition between the first transport section (42) and the second transport section (44). The dies (26) have preferably been filled with a tablet material before the insertion of the inserts (12), so that the inserts (12) are preferably deposited on the tablet material. It is preferred in terms of the invention that the tablet material comprises manganese dioxide powder, which can be filled, for example, using a filling device in the dies (26) of the die plate (28). When the supporting mesh has been deposited on the tablet material, the pressing material can be compressed together with the supporting mesh to form a pellet, for example using the pre-pressing and/or main pressing station (not shown) of the tablet machine (14).

The transfer unit (24) can preferably comprise transfer means (40), which can be designed, for example as transfer arms. The transfer arms (40) can be provided in an extended or in a non-extended state, wherein they have a working length in the extended state. Furthermore, the transfer means (40) can be raised. For this purpose, the acceptance device (26) can have control means, which are designed as control curves, for example. In the front region, the transfer means (40) can comprise heads (46), which can be designed to accept the inserts from the carriers. The transfer heads (46) can include bores, to which vacuum, negative pressure, or compressed air can be applied. For this purpose, the transfer unit (24) can preferably comprise fittings and/or feed and exhaust lines for the vacuum, the negative pressure, or the compressed air. The transfer unit (24) can furthermore comprise a gear rim (38), wherein the gear rim (38) is provided arranged below the transfer means (40) and is designed to accept the carriers (20) from the transfer unit (18).

FIG. 3 shows a preferred embodiment of a stamping unit (16) and a material unit. The material unit comprises, in a region upstream of the stamping unit (16), a feed roll (32) for fresh strip-shaped material (22) for the production of the inserts (12), and a tensioning roll (23), which holds the strip-shaped material (22) to be fed at a height for the stamping unit (16). In a region downstream of the stamping unit (16), the material unit comprises a further tensioning roll (23) for holding down the stamped-out residual strip (36), and a roll (34) for receiving it. In particular, FIG. 3 shows a stamping unit (16) having strip feed (32) and strip discharge (34). It is preferred in terms of the invention that the stamping unit (16) is provided arranged between the elements of the material unit, and that the stamping unit (16) and the material unit are provided in the region of the first transport belt section (42) of the transport unit (18).

FIG. 4 shows a preferred embodiment of a transfer unit (24). In particular, FIG. 4 shows the transport of the carriers (20) filled with the stamped-out inserts (12) to the transfer unit (24), which can comprise movable transfer arms (40). The carriers (20) loaded with the stamped-out inserts (12) are accepted at the end of the first transport belt section (42) of the transport unit (18) by the gear rim (38) of the transfer unit (24) and guided in a circle in recesses of the gear rim (38). In particular, the gear rim (38) for guiding the carriers (20) is provided below the transfer arms (40). The transfer arms (40) are initially provided in the non-extended state and in this state accept the inserts (12) from the upper sides of the carriers (12), which can include guides, for example, for better holding of the inserts (12). After completed acceptance of the inserts (12) by the transfer means (40) or the heads (46) of the transfer heads (40), the transfer arms (40) move and enter a working state. Vacuum or negative pressure can be applied to the transfer heads (46), for example, to be able to hold the inserts (12) better. In the extended states, the transfer arms (40) or their heads (46) pass over a subregion of the die plate (28) for a certain time span, so that a sufficiently long time period for a reliable and precise transfer of the inserts (12) into the openings (26) of the die plate (28) remains. The transfer arms (40) go back into the retracted state after completed delivery of the inserts, until a new insert (12) is received again at the end of the first transport belt section (42). The empty carriers (20) are initially conveyed further using the gear rim (38), preferably up to the beginning of the second transport belt section (44). The carriers (20) are transferred there to the second transport belt (44) and transported by the transport unit (18) along the second transport belt section (44).

FIG. 5 shows an exemplary transfer process of the inserts (12) from the transport unit (18) to the tablet machine (14) by the transfer unit (24). In particular, FIG. 5 shows the movement of the transfer arms (40) with the acceptance of the inserts (12) by means of vacuum, the feed of the carriers (20) filled with the inserts (12) to the die plate (28) of the tablet machine (14), wherein the die plate (28) comprises the dies (26) filled with the pressing material, wherein the inserts (12) are inserted on the tablet material. The extension process of the transfer arms (40) from a retracted or non-extended state into an extended state, in which the inserts (12) are transferred to the openings (26) of the die plate (28), can be seen clearly in FIG. 5.

### LIST OF REFERENCE SIGNS

10 device
12 insert, in particular supporting mesh
14 tablet machine, for example rotary press
16 stamping unit
18 transport unit
20 carrier
22 strip-shaped material
24 transfer unit
26 openings
28 die plate
30 lifting apparatus for the carriers
32 means for supplying the strip-shaped material
34 means for receiving a stamped-out strip-shaped material
36 stamped-out strip-shaped material
38 gear rim
40 transfer means
42 first transport belt section
44 second transport belt section
46 transfer heads
48 third transport belt section/cross transport device

1. A device (10) for providing supporting meshes for use as inserts (12) in a pellet on a tablet machine (14),
characterized in that
the device (10) comprises a stamping unit (16) and a transport unit (18) having carriers (20), wherein the stamping unit (16) is designed to stamp the inserts (12) out of a strip-shaped material (22), wherein the strip-shaped material (22) is a wire mesh strip, and to transfer the inserts to the carriers (20) of the transport unit (18), wherein the stamped-out inserts (12) are transported on the carriers (20) to a transfer unit (24), wherein the transfer unit (24) is designed to accept the stamped-out inserts (12) from the carriers (20) and insert them into openings (26) of a die plate (28) of the tablet machine (14), so that the stamped-out inserts (12) form supporting meshes, which are processable by the tablet machine (14) with a tablet material to form a pellet.

2. The device (10) as claimed in claim 1
characterized in that
the stamping unit (16) comprises a number of N stamping means (16), wherein the stamping means (16) are designed to stamp the inserts (12) as supporting meshes out of the strip-shaped material (22).

3. The device (10) as claimed in claim 1 or 2
characterized in that
the stamping unit (16) is designed to stamp the inserts (12) as supporting meshes having a circular footprint out of the strip-shaped material (22), wherein the inserts (12) preferably have a diameter of 10 cm to 22 cm.

4. The device (10) as claimed in claim 1 or 2
characterized in that
the carriers (20) can be raised in the region of the stamping unit (16) using a lifting apparatus (30).

5. The device (10) as claimed in one or more of the preceding claims
characterized in that
the device (10) comprises means (32) for supplying the strip-shaped material (22) and means (34) for receiving a stamped-out strip-shaped material (36).

6. The device (10) as claimed in the preceding claim
characterized in that
the means (32) for supplying the strip-shaped material (22) comprise a feed roll, on which a wire mesh strip is provided rolled up, and a holding-down unit (23) for providing the strip-shaped material (22) for the stamping unit (16) at a suitable height.

7. The device (10) as claimed in claim 5
characterized in that
the means (34) for receiving a stamped-out strip-shaped material (36) comprise a receiving roll and a holding-down unit (23) for accepting the stamped-out strip-shaped material (22) from the stamping unit (16) at a suitable height.

8. The device (10) as claimed in one or more of the preceding claims
characterized in that
the transfer unit (24) includes transfer means (40) for accepting the stamped-out inserts (12) from the carriers (20) and for transferring the stamped-out inserts (12) into the openings (26) of a die plate (28).

9. The device (10) as claimed in claim 8
characterized in that
the transfer unit (24) comprises a gear rim (38), wherein the gear rim (38) is provided arranged below the transfer means (40) and is designed to accept the carriers (20) from the transport unit (18).

10. The device (10) as claimed in one or more of the preceding claims
characterized in that
the transport unit (18) comprises two essentially parallel transport sections (42, 44), wherein the stamping unit (16) is provided arranged in a first transport section (42).

11. A system comprising a device as claimed in any one of the preceding claims and a tablet machine, wherein the device is designed to provide supporting meshes for use as inserts (12) in a pellet and to transfer them to the tablet machine (14).

12. The system as claimed in the preceding claim
characterized in that the tablet machine (14) comprises a die plate (28) and the system is designed so that a movement of the transfer unit (24) of the device (10) takes place synchronously with a movement of the die plate (28) of the tablet machine (14).

13. The system as claimed in one of preceding claim 11 or 12
characterized in that
the transfer unit (24) is designed so that transfer means (40) in an extended state pass over a pitch circle of the die plates (28) of the tablet machine (14).

14. The system as claimed in one of preceding claims 11 to 13
characterized in that the tablet machine comprises a die plate (28) having die bores (26) and the stamping unit (16) is designed to stamp the inserts (12) as supporting meshes having a circular footprint out of the strip-shaped material (22), wherein the inserts (12) have a diameter which is smaller by 0.02 mm to 1 mm, preferably 0.05 mm to 0.2 mm, particularly preferably approximately 0.1 mm, than the diameter of the die bores (26).

15. A method for producing a pellet, which includes an insert (12) as a supporting mesh,
comprising the following steps:
a) providing a strip-shaped material (22), which is a wire fabric, to a stamping unit (16),
b) stamping inserts (12) as supporting meshes out of the strip-shaped material (22) in the stamping unit (16),
c) transporting the stamped-out inserts (12) to a transfer unit (24),
d) transferring the stamped-out inserts (12) by way of the transfer unit (24) into openings (26) of a die plate (28) of a tablet machine (14),
e) producing a pellet which includes an insert (12).

16. The method as claimed in the preceding claim
characterized in that:
the transfer of the inserts (12) into openings (26) of the die plate (28) of the tablet machine (14) takes place after filling of a pressing material into the openings (26), so that during subsequent compression, the inserts (12) are pressed as supporting meshes into the surface of the pellet and stabilize the pellet.

17. The method as claimed in claim 16
characterized in that
the stamping out of the inserts (12) takes place cyclically, while the feed of the stamped-out inserts (12) to the tablet machine (14) takes place continuously.

18. The method as claimed in any one of preceding claims 15 to 17
characterized in that
after production of the pellet having the insert (12) in the tablet machine, the pellets are dried by means of a heat treatment, wherein the heat treatment preferably takes place over a time period of more than 6 hours, preferably more than 12 hours.

19. The method as claimed in any one of preceding claims 15 to 18
characterized in that
the transport of the stamped-out inserts (12) to the transfer unit (24) comprises the following further steps:
c1) providing carriers (20) by way of the transport unit (18),
c2) receiving the stamped-out inserts (12) by way of the carriers (20) in the stamping unit (16).

20. The device (20) as claimed in one or more of claims 1 to 10, the system as claimed in one of claims 11 to 14, or the method as claimed in one or more of claims 15 to 19
characterized in that
the pellets comprise a metal oxide powder.

21. The device (10) or the method as claimed in the preceding claim
characterized in that
the metal oxide powder comprises manganese dioxide.
